(19) United States
(12) Patent Application Publication
(10) Pub. No.: US 2021/0297898 A1
(43) Pub. Date: Sep. 23, 2021

(54) WIRELESS COMMUNICATION METHOD FOR REDUCING THE RECEIVAL OF UNWANTED DATA AND USER EQUIPMENT THEREOF

(71) Applicant: MEDIATEK INC., Hsinchu City (TW)

(72) Inventors: Chih-Yuan TSAI, Hsinchu City (TW); I-Wei TSAI, Hsinchu City (TW); Jun-Jie SU, Hsinchu City (TW); Yi-Lun CHEN, Hsinchu City (TW)

(21) Appl. No.: 16/820,854

(22) Filed: Mar. 17, 2020

(51) Int. Cl. H04W 28/06; H04L 29/08

(52) U.S. Cl. CPC H04W 28/06; H04W 80/06; H04L 67/143

(57) ABSTRACT

A wireless communication method for reducing the receival of unwanted data is provided. The wireless communication method for a TCP session includes the steps of determining whether a TCP session associated with a first subscriber identity module (SIM) of the UE is not required; and in response to determining that the TCP session is not required, the processor terminates the TCP session.

### BACKGROUND OF THE INVENTION

### Field of the Invention

The invention generally relates to a wireless communication technology, and more particularly, to a wireless communication method for reducing the receival of unwanted data.

### Description of the Related Art

In conventional communication technology, when one Subscriber Identity Module (SIM) of user equipment (UE), e.g. a SIM card, is disabled or network service is switched off, a transmission control protocol (TCP) session associated with the SIM may not be ended properly and will remain active. In such case, the data packets associated with the TCP session will keep being generated and becoming garbage packets to influence efficiency of the network service operating with other SIM as examples illustrated in FIGS. 1A and 1B.

FIG. 1A is a schematic diagram illustrating a problem with the TCP session of the prior art. As shown in FIG. 1A, when an UE A, which has a SIM1_A, is powered on, the network assigns an IP address IP A1 to SIM1_A and then a TCP session associated with the SIM1_A is established and bound with IP A1 for running a network service. When the SIM1_A is disabled, the UE A may not correspondingly close the network socket for the TCP session associated with the SIM1_A. In such case, the TCP session is not correspondingly closed and is still bound with IP A1. When the UE B is powered on after the disablement of the SIM1_A, the network assigns an IP address IP B1 to the SIM1_B of the UE B and reassigns the IP A1, which had been assigned to the SIM1_A, to the SIM2_B of the UE B. Therefore, the data packets, which are generated on TCP session associated with SIM1_A, are received by SIM2_B, even if those data packets are meaningless, useless and will be processed as garbage packets. Those garbage packets cause that the network service performed on the SIM1_B is frequently interrupted because SIM2_B cannot tell the incoming paging is for a voice call or garbage packets due to the limited receiver resource in the UE B.

FIG. 1B is a schematic diagram illustrating another problem with the TCP session of the prior art. As shown in FIG. 1B, when the UE B is powered on, the network assigns the IP B1 to SIM1_B of the UE B and then a TCP session associated with the SIM1_B is established and bound with IP B1 for running a network service. When the network service is switched from the SIM1_B to the SIM2_B of the UE B, the UE B does not correspondingly close the network socket for the TCP session associated with the IP B 1. Therefore, the data packets, which are generated on TCP session associated with SIM1_B, are received by SIM2_B, even if those data packets are meaningless, useless and will be processed as garbage packets. Those garbage packets cause that the network service performed on the SIM2_B is frequently interrupted because SIM1_B cannot tell the incoming paging is for a voice call or garbage packets due to the limited receiver resource in the UE B.

Therefore, when a network service performed with one SIM of UE is frequently interrupted, a bad user experience will be introduced.

### BRIEF SUMMARY OF THE INVENTION

The present application proposes a wireless communication method for reducing the receival of unwanted data and user equipment (UE) thereof to overcome the problems mentioned above.

In one aspect of the application, the method, executed by a processor of UE, comprises the steps of: determining whether a TCP session associated with a first subscriber identity module (SIM) of the UE is not required. The method may also involve that the processor terminates the TCP session in response to determining that the TCP session is not required.

In one aspect of the application, the UE comprises a first subscriber identity module (SIM) and a processor. The processor determines whether a TCP session associated with the first SIM is not required, and in response to determining that the TCP session is not required, the processor terminates the TCP session.

In one aspect of the application, the method comprises the steps of: receiving a down link (DL) data packet for a first TCP session associated with a first SIM of the UE from a network; and transmitting an uplink (UL) data packet for the first TCP session to the network, when the first TCP session is determined to be not required, wherein a field of a window size of the UL data packets is modified as 0.

Other aspects and features of the invention will become apparent to those with ordinary skill in the art upon review of the following descriptions of specific embodiments of wireless communication methods and user equipment.

### BRIEF DESCRIPTION OF THE DRAWINGS

The invention will become more fully understood by referring to the following detailed description with reference to the accompanying drawings, wherein:

FIG. 1A is a schematic diagram illustrating a problem with the TCP session of the prior art.

FIG. 1B is a schematic diagram illustrating another problem with the TCP session of the prior art.

FIG. 2 is a block diagram of a wireless communication system 100 according to an embodiment of the invention.

FIG. 3 is a block diagram of the UE 120 according to an embodiment of the invention.

FIG. 4 is a schematic diagram illustrating a wireless communication method according to an embodiment of the invention.

FIG. 5 is a schematic diagram illustrating a wireless communication method according to another embodiment of the invention.

FIG. 6 is a flow chart 600 illustrating a wireless communication method according to an embodiment of the invention.

FIG. 7 is a flow chart 700 illustrating a wireless communication method according to another embodiment of the invention.

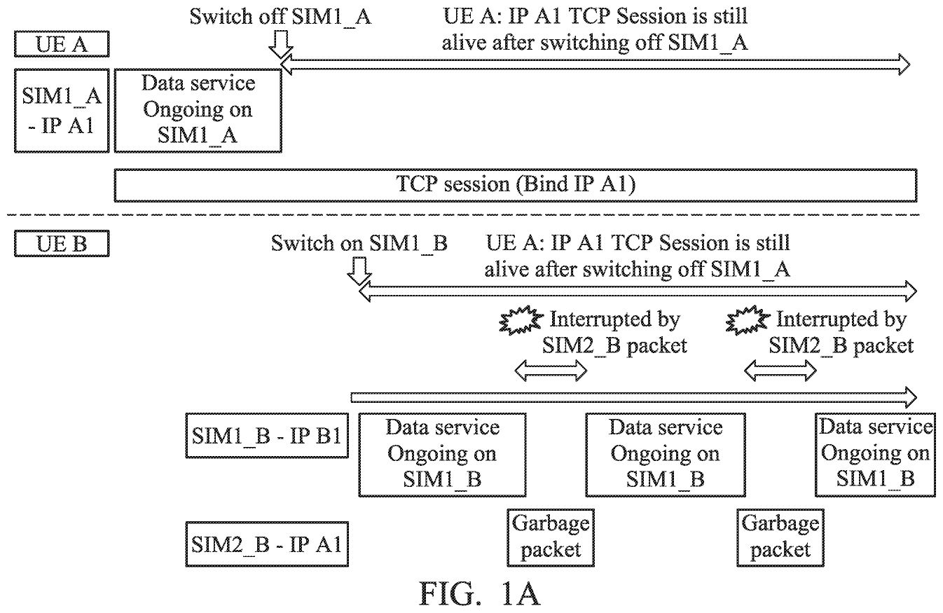

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

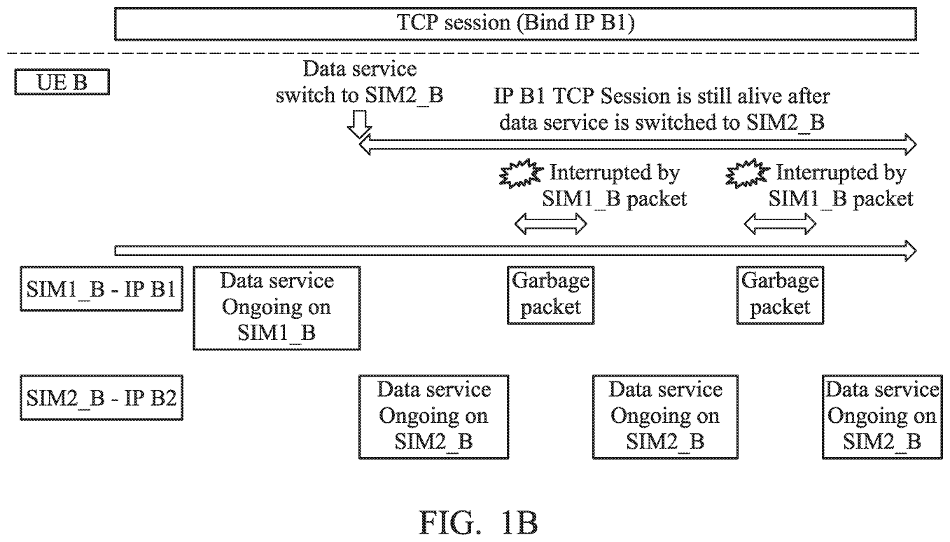

FIG. 2 is a block diagram of a wireless communication system 100 according to an embodiment of the invention. The wireless communication system 100 comprises a base station 110 and user equipment (UE) 120. Note that, in order to clarify the concept of the invention, FIG. 2 is a simplified block diagram in which only the elements relevant to the invention are shown. However, the invention should not be limited to what is shown in FIG. 2.

In the embodiments of the invention, the base station 110 may be a base transceiver station (BTS), a NodeB, an evolved NodeB (eNB), a next generation NodeB (gNB), a radio access point (RAN) node, and so on. In the embodiments of the invention, the UE 120 may be a smartphone, Personal Data Assistant (PDA), pager, laptop computer, desktop computer, wireless handset, or any computing device that includes a wireless communications interface.

In the embodiments of the invention, the base station 110 may communicate with the UE 120 through the third generation (3G) radio access technology (e.g. Wideband Code Division Multiple Access (WCDMA)), the fourth generation (4G) radio access technology (e.g. Long Term Evolution (LTE)) or the fifth generation (5G) New Radio (NR) radio access technology, but the invention should not be limited thereto.

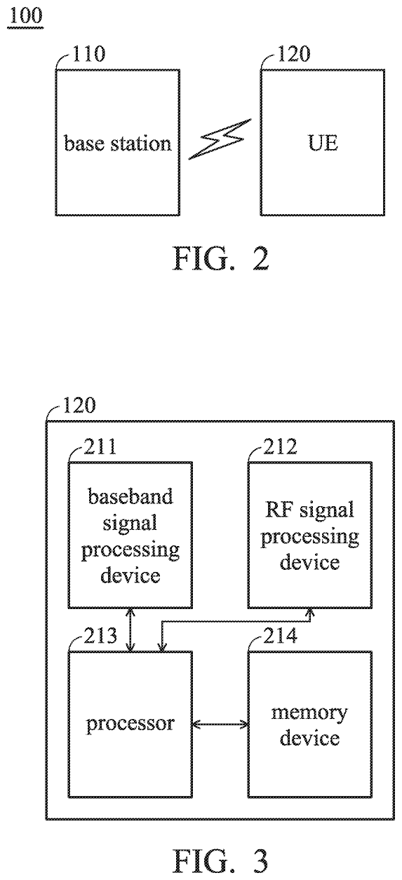

FIG. 3 is a block diagram of the UE 120 according to an embodiment of the invention. As shown in FIG. 3, the UE 120 may comprise at least a baseband signal processing device 211, an radio frequency (RF) signal processing device 212, a processor 213, a memory device 214, and an antenna module comprising at least one antenna. Note that, in order to clarify the concept of the invention, FIG. 3 presents a simplified block diagram in which only the elements relevant to the invention are shown. However, the invention should not be limited to what is shown in FIG. 3.

The RF signal processing device 212 may receive RF signals via the antenna and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing.

The processor 213 may control the operations of the baseband signal processing device 211 and the RF signal processing device 212. According to an embodiment of the invention, the processor 213 may also be arranged to execute the program codes of the software module(s) of the corresponding baseband signal processing device 211 and/or the RF signal processing device 212. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software module(s).

The memory device 214 may store the software and firmware program codes, system data, user data, etc. of the UE 120. The memory device 214 may be a volatile memory such as a Random Access Memory (RAM); a non-volatile memory such as a flash memory or Read-Only Memory (ROM); a hard disk; or any combination thereof.

According to an embodiment of the invention, the RF signal processing device 212 and the baseband signal processing device 211 may collectively be regarded as a communication device capable of communicating with a wireless network to provide wireless communications services in compliance with a predetermined Radio Access Technology (RAT). Note that, in some embodiments of the invention, the UE 120 may be extended further to comprise more than one antenna and/or more than one radio module, and the invention should not be limited to what is shown in FIG. 3.

In addition, in some embodiments of the invention, the processor 213 may be configured inside of the baseband signal processing device 211, or the UE 120 may comprise another processor configured inside of the baseband signal processing device 211. Thus the invention should not be limited to the architecture shown in FIG. 3.

In an embodiment of the invention, the UE 120 may have two subscriber identity module (SIM) (e.g. a first SIM and a second SIM may be in a form of card) and the UE 120 may support a dual-SIM dual-standby (DSDS) function. That is to say, the two SIM of the UE 120 may share the usage of the same RF module. When the RF module is scheduled to process the data or signal associated to one SIM of them, the data or signal associated to the other SIM needs to wait for its turn to be processed by the RF module.

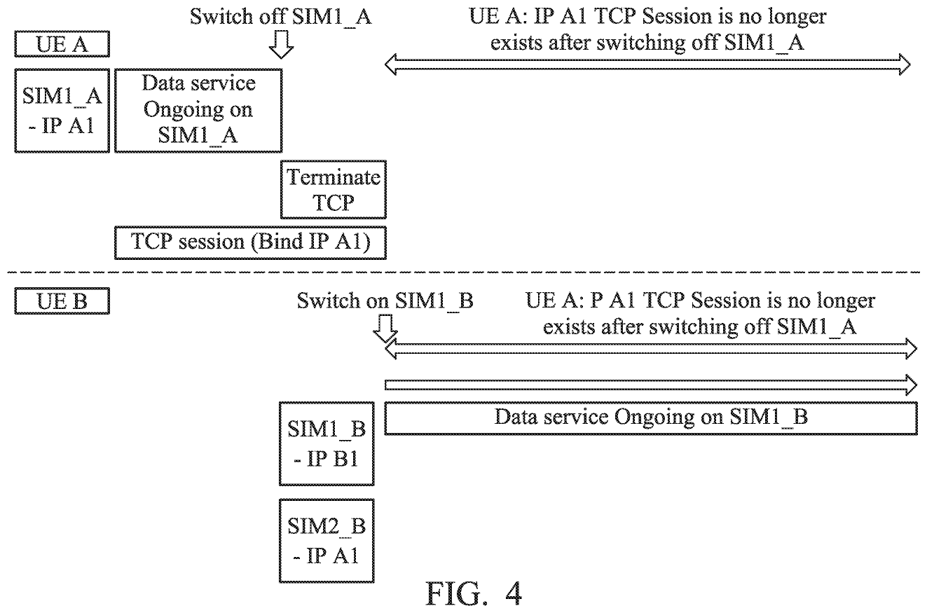

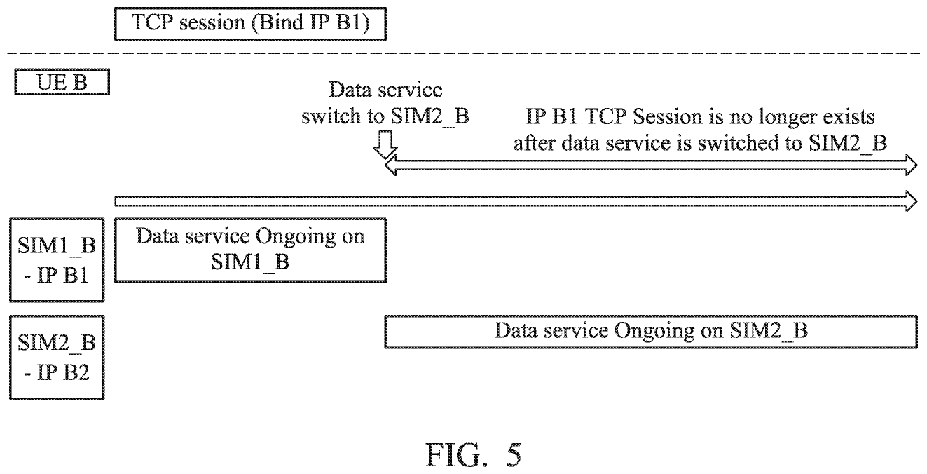

In an embodiment of the invention, the processor 213 of the UE 120 may determine whether a transmission control protocol (TCP) session associated with the first SIM is not required. When the processor 213 of the UE 120 determines that the TCP session associated with the first SIM is not required, the processor 213 of the UE 120 may terminate the TCP session associated with the first SIM card. In an embodiment of the invention, the processor 213 of the UE 120 may determine that the TCP session is not required when the SIM associated with the TCP session is disabled. In another embodiment of the invention, the processor 213 of the UE 120 may determine that the TCP session is not required when a data service performed on the first SIM of the UE 120 is switched to the second SIM. FIGS. 4 and 5 are taken for example to illustrate the embodiments of the invention below.

FIG. 4 is a schematic diagram illustrating a wireless communication method according to an embodiment of the invention. The wireless communication method for the TCP session shown in FIG. 4 can be applied to communication system 100. As shown in FIG. 4, when the UE A is enabled, the data service is performed on the SIM1_A of the UE A and the network assigns an IP A1 for the TCP session associated with the SIM1_A. When the SIM1_A of the UE A is disabled, the UE A may terminate the TCP session associated with the SIM1_A (i.e. the TCP session binding with the IP A1) actively. That is to say, the UE A may determine that the TCP session associated with the SIM_A is not required. Therefore, if the network assigns the IP A1 to another SIM later, the garbage packets for the terminated TCP session will not be generated. Specifically, as shown in FIG. 4, when the UE B is enabled after the SIM1_A is disabled, the network may assign an IP B1 for the TCP session associated with the SIM1_B of UE B and assigns the IP A1 (the SIM1_A used before) for the TCP session associated with the SIM2_B. When a data service is performed on the SIM1_B, the data service performed on the SIM1_B will not be interrupted by the garbage packet, because the SIM2_B does not receive the garbage packet.

FIG. 5 is a schematic diagram illustrating a wireless communication method for a TCP session according to another embodiment of the invention. The wireless communication method for the TCP session shown in FIG. 5 can be applied to communication system 100. As shown in FIG. 5, when the UE B is enabled, the data service is performed on the SIM1_B of the UE B and the network assigns the IP B1 for the TCP session associated with the SIM1_B. When the data service is switched from the SIM1_B to the SIM2_B of the UE B, the UE B may terminate the TCP session associated with the SIM1_B (i.e. the TCP session binding with the IP B1) actively. That is to say, the UE B may determine that the TCP session associated with the SIM1_B is not required. Therefore, the garbage packet for the TCP session associated with the SIM1_B will not be generated such that the data service performed on the SIM2_B will not be interrupted by the garbage packet to the SIM1_B.

According to an embodiment of the invention, when the first SIM of the UE 120 is used for a data service connecting with a network via the baseband 110, the UE 120 may receive a down link (DL) data packet for the TCP session associated with the first SIM of the UE 120. In the meanwhile, if a DL data packet for the TCP session associated with the second SIM of the UE 120 is also received by the UE 120, the DL data packet for the TCP session associated with the second SIM card of the UE 120 may be a garbage packet. An uplink (UL) data packet for the TCP session associated with the second SIM may be transmitted to the network in such case, wherein a field of a window size of the UL data packet may be modified (or set) to 0 by the processor in the UE 120. Furthermore, in an embodiment of the invention, before the field of the window size of the UL data packet is modified to 0, all the UL packets for the TCP session associated with the second SIM may be filtered out by the processor in the UE 120. Furthermore, a TCP header checksum may be calculated by the processor of the UE 120 to ensure that the network may accept the modification for the field of the window size of the UL data packet for the TCP session associated with the second SIM. After the network receiving the modified UL data packet for the TCP session associated with the second SIM, the network will stop to transmit the DL data packet for the TCP session associated with the second SIM such that the data service performing with the first SIM will not be interrupted by the data packet for the TCP session associated with the second SIM.

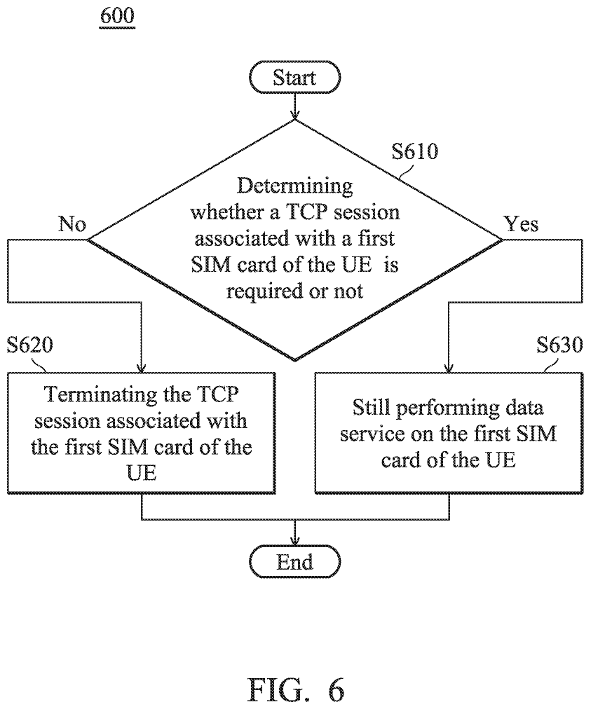

FIG. 6 is a flow chart 600 illustrating a wireless communication method for transmission control protocol (TCP) session according to an embodiment of the invention. The wireless communication method can be applied to the UE 120. As shown in FIG. 6, in step S610, the UE 120 may determine whether a TCP session associated with a first SIM of the UE 120 is required or not. If the TCP session is not required, step S620 is performed. In step S620, the UE 120 may terminate the TCP session associated with the first SIM. If the TCP session is still be required, step S630 is performed. In the step S630, the UE 120 may still perform data service with the first SIM.

In some embodiments of the invention, in the wireless communication method, the UE 120 may support a dual-SIM dual-standby (DSDS) function and the UE 120 further comprises a second SIM. In some embodiments of the invention, in the wireless communication method, the data service may be switched from the first SIM to the second SIM card.

In some embodiments of the invention, in the wireless communication method, the TCP session associated with the first SIM of the UE 120 is determined to be not required when the data service is switched from the first SIM to the second SIM.

In some embodiments of the invention, in the wireless communication method, the TCP session associated the first SIM of the UE 120 is determined to be not required when the first SIM is disabled.

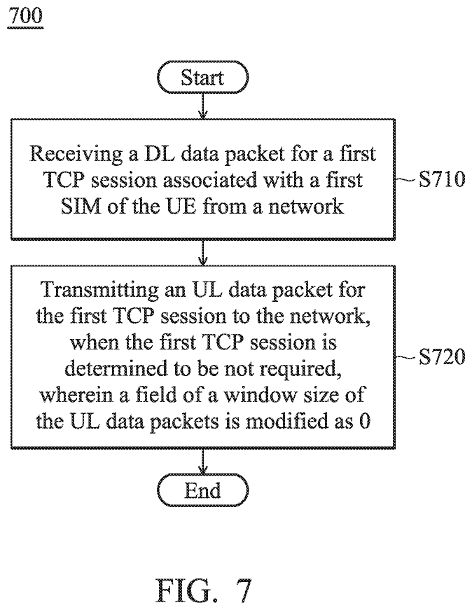

FIG. 7 is a flow chart 700 illustrating a wireless communication method according to another embodiment of the invention. The wireless communication method can be applied to the UE 120. As shown in FIG. 7, in step S710, the UE 120 receives a down link (DL) data packet for a first TCP session associated with a first SIM of the UE 120 from a network. In step S720, the UE 120 may transmit an uplink (UL) data packet for the first TCP session to the network when the first TCP session is determined to be not required, wherein a field of a window size of the UL data packets is modified to 0.

In some embodiment of the invention, in the wireless communication method, the UE 120 may filter out all UL packets for the first TCP session, modify the window size of the UL data packets to 0, and calculate a TCP header checksum.

Accordingly, in the wireless communication methods of the invention, the UE can terminate the TCP session associate with one SIM of the UE actively when the SIM is disabled. Furthermore, in the communication methods of the invention, the UE may modify the window size of the UL data packet to terminate the TCP session which is not required. Therefore, in the communication methods of the invention, the data service performed on one SIM of the UE will not be interrupted by data packet for another TCP session which is not required.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication method, comprising:
determining, by a processor of a user equipment (UE), whether a transmission control protocol (TCP) session associated with a first subscriber identity module (SIM) of the UE is not required; and
in response to determining that the TCP session is not required, terminating, by the processor, the TCP session.

2. The wireless communication method of claim 1, wherein the processor supports a dual-SIM dual-standby (DSDS) function.

3. The wireless communication method of claim 1, further comprising:
switching a data service from the first SIM to a second SIM in the UE.

4. The wireless communication method of claim 3, wherein in response to the switching the data service from the first SIM to the second SIM, it is determined that the TCP session is not required.

5. The wireless communication method of claim 1, wherein in response to disabling the first SIM card, it is determined that the TCP session is not required.

6. A wireless communication method, comprising:
receiving, by a processor of a user equipment (UE), a down link (DL) data packet for a first transmission control protocol (TCP) session associated with a first SIM of the UE from a network; and
transmitting, by the processor, an uplink (UL) data packet for the first TCP session to the network in response to determining the first TCP session is not required, wherein a field of a window size of the UL data packets is 0.

7. The wireless communication method of claim 6, further comprising:
filtering out all UL packets for the first TCP session;
modifying the window size of the UL data packets to 0; and
calculating a TCP header checksum.

8. An apparatus implemented as a user equipment (UE), comprising:
a communication device configured to wirelessly communicate with a network;
a first subscriber identity module (SIM); and
a processor coupled to the communication device, wherein operations performed by the processor comprises:
determining whether a transmission control protocol (TCP) session associated with the first SIM is not required; and
in response to determining that the TCP session is not required, terminating the TCP session.

9. The apparatus of claim 8, wherein the processor supports a dual-SIM dual-standby (DSDS) function.

10. The apparatus of claim 8, wherein the processor further switches a data service from the first SIM to performing with a second SIM.

11. The apparatus of claim 10, wherein in response to the data service is switched from the first SIM to the second SIM, the processor determines that the TCP session is not required.

12. The apparatus of claim 8, wherein in response to the processor disables the first SIM card, the processor determines that the TCP session is not required.
